(19) United States
(12) Patent Application Publication
(10) Pub. No.: US 2023/0214425 A1
(43) Pub. Date: Jul. 6, 2023

(54) Node Embedding via Hash-Based Projection of Transformed Personalized PageRank

(71) Applicant: Google LLC, Mountain View, CA (US)

(72) Inventors: Bryan Perozzi, Cranford, NJ (US); Anton Tsitsulin, Moscow (RU); Silvio Lattanzi, Zurich (CH); Filipe Miguel Conçalves de Almeida, Zurich (CH); Yingtao Tian, Tokyo (JP); Stefan Postavaru, Curich (CH)

(21) Appl. No.: 17/927,494

(22) PCT Filed: Sep. 24, 2020
(86) PCT No.: PCT/US2020/052461

§ 371 Date: Nov. 23, 2022

(51) Int. Cl. G06F 16/901

(52) U.S. Cl. CPC G06F 16/9024

(57) ABSTRACT

Systems and methods for generating single-node representations in graphs comprised of linked nodes. The present technology enables generation of individual node embeddings on the fly in sublinear time (less than O(n), where n is the number of nodes in graph G) using only a PPR vector for the node, and random projection to reduce the dimensionality of the node’s PPR vector. In one example, the present technology includes a computer-implemented method comprising obtaining a graph having a plurality of nodes from a database, generating a personal pagerank vector for a given node of the plurality of nodes, and producing an embedding vector for the given node by randomly projecting the personal pagerank vector, wherein the embedding vector has lower dimensionality than the personal pagerank vector.

### BACKGROUND

Graphs may be used to model a wide variety of interesting problems where data can be represented as objects connected to each other, such as in social networks, computer networks, chemical molecules, and knowledge graphs. In many cases, it is beneficial to generate embedded representations of graphs in which a d-dimensional embedding vector is assigned for each node in a given graph G. Such node embeddings may be used for downstream machine learning tasks, such as visualization (e.g., where a high-dimensional graph is reduced to a lower dimension), node classification (e.g., where missing information in one node is predicted using features of adjacent nodes), anomaly detection (e.g., where anomalous groups of nodes are highlighted), and link predictions (e.g., where new links between nodes are predicted, such as suggesting new connections in a social network).

Existing approaches for generating graph embeddings typically assume that graph data easily fits in memory and is stable. However, in many cases, graph data may in fact be large, making it difficult or infeasible to store and/or process on certain devices (e.g., personal computers, mobile devices). Likewise, in many cases, graph data may be volatile, and thus may become too stale to rely upon for certain tasks (e.g., social networks are constantly changing with new users joining and new relationships forming). Given that network embedding generally must be consistent across all nodes in the graph data, a standard approach to dealing with this changing behavior is to rerun the embedding algorithm on a regular (e.g., weekly) basis, in order to balance the time necessary to generate new graph representations with the need for representations that are as up-to-date as possible. At the same time, many of the common uses for graph embeddings such as node classification may only require current representations for a single node or a small set of nodes, making it particularly inefficient to recompute an entire graph embedding on an as-needed basis.

In response, the present technology proposes systems and methods in which the embedding for a node is restricted to using only local structural information, and cannot access the representations of other nodes in the graph or rely on trained global model state. In addition, the present technology can produce embeddings which are consistent with the representations of the other nodes in the graph, so that the new node embeddings can be incorporated with the rest of the graph embedding and used for downstream tasks. To accomplish this, the present technology proposes systems and methods which leverage a high-order ranking matrix based on global Personalized PageRank (“PPR”) as foundations on which local node embeddings are computed with local PPR Hashing. These systems and methods can produce node embeddings that are comparable to state-of-the-art methods in terms of quality, but with efficiency several orders of magnitude better in terms of clock time and short-term memory consumption. For example, the systems and methods can be configured to produce node embeddings that fit into the volatile memory of a desktop and/or mobile computing device. Moreover, these systems and methods make it possible to update different node embeddings in parallel, for example in a server-farm system and/or a multi-processor or multi-core processor based system, making it possible to field multiple simultaneous queries, and to base each response on locally updated embeddings specific to each query. Finally, these systems and methods make it possible to tailor processing so as to provide embeddings within preset amount of time, which enables the present technology to be applied in contexts such as fraud-detection where embeddings must be generated in a guaranteed amount of time (e.g., 200 ms).

### BRIEF SUMMARY

The present technology concerns improved systems and methods for generating single-node representations in graphs comprised of linked nodes. In that regard, the present technology provides systems and methods for generating individual node embeddings on the fly in sublinear time (less than O(n), where n is the number of nodes in graph G) using only a PPR vector for the node, and random projection to reduce the dimensionality of the node’s PPR vector.

In one aspect, the disclosure describes a processing system, comprising a memory, and one or more processors coupled to the memory and configured to perform the following operations: obtain a graph having a plurality of nodes from a database; generate a personal pagerank vector for a given node of the plurality of nodes; and produce an embedding vector for the given node by randomly projecting the personal pagerank vector, wherein the embedding vector has lower dimensionality than the personal pagerank vector. In some aspects, the one or more processors are further configured to perform the following operations, and to perform one or more of the following operations in parallel with one or more of the operations of claim 1: generate an additional personal pagerank vector for an additional node of the plurality of nodes, the additional node being different from the given node; and produce an additional embedding vector for the additional node by randomly projecting the additional personal pagerank vector, wherein the additional embedding vector has lower dimensionality than the additional personal pagerank vector. In some aspects, the one or more processors are further configured to generate the personal pagerank vector for the given node based at least in part on a precision value. In some aspects, the one or more processors are further configured to generate the personal pagerank vector for the given node based at least in part on a return probability. In some aspects, the one or more processors are further configured to generate the personal pagerank vector as a sparse vector. In some aspects, the one or more processors are further configured to produce the embedding vector for the given node by randomly projecting the personal pagerank vector based at least in part on a preselected dimensionality for the embedding vector. In some aspects, the one or more processors are further configured to produce the embedding vector for the given node by randomly projecting the personal pagerank vector based at least in part on a one or more hashing functions. In some aspects, the one or more processors are further configured to update an embedding for the graph based on the embedding vector for the given node. In some aspects, the one or more processors are further configured to produce a link prediction based at least in part on the embedding vector for the given node, wherein the link prediction represents a prediction of a new link between the given node and another of the plurality of nodes. In some aspects, the one or more processors are further configured to produce a node classification based at least in part on the embedding vector for the given node, wherein the node classification represents a prediction of information to be associated with the given node based on one or more features of other nodes of the plurality of nodes that are adjacent to the given node.

In another aspect, the disclosure describes a computer-implemented method, comprising steps of: obtaining, with one or more processors of a processing system, a graph having a plurality of nodes from a database; generating, with the one or more processors, a personal pagerank vector for a given node of the plurality of nodes; and producing, with the one or more processors, an embedding vector for the given node by randomly projecting the personal pagerank vector, wherein the embedding vector has lower dimensionality than the personal pagerank vector. In some aspects, the method further comprises the following steps, one or more of which are performed in parallel with one or more of the steps of claim 11: generating, with the one or more processors, an additional personal pagerank vector for an additional node of the plurality of nodes, the additional node being different from the given node; and producing, with the one or more processors, an additional embedding vector for the additional node by randomly projecting the additional personal pagerank vector, wherein the additional embedding vector has lower dimensionality than the additional personal pagerank vector. In some aspects, generating the personal pagerank vector for the given node is based at least in part on a precision value. In some aspects, generating the personal pagerank vector for the given node is based at least in part on a return probability. In some aspects, the personal pagerank vector is a sparse vector. In some aspects, producing the embedding vector for the given node by randomly projecting the personal pagerank vector is based at least in part on a preselected dimensionality for the embedding vector. In some aspects, producing the embedding vector for the given node by randomly projecting the personal pagerank vector is based at least in part on one or more hashing functions. In some aspects, the method further comprises updating the embedding for the graph based on the embedding vector for the given node. In some aspects, the method further comprises producing a link prediction based at least in part on the embedding vector for the given node, wherein the link prediction represents a prediction of a new link between the given node and another of the plurality of nodes. In some aspects, the method further comprises producing a node classification based at least in part on the embedding vector for the given node, wherein the node classification represents a prediction of information to be associated with the given node based on one or more features of other nodes of the plurality of nodes that are adjacent to the given node.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIG. 3 is a flow diagram showing an exemplary method for generating a local node embedding for a selected node v in a graph G with n total nodes, in accordance with aspects of the disclosure.

FIG. 4 is a flow diagram showing an exemplary method for generating a PPR vector for a selected node v in a graph G with n total nodes, in accordance with aspects of the disclosure.

FIG. 5 is a flow diagram showing an exemplary method for performing random projection of a PPR vector to generate a local node embedding for a selected node v, in accordance with aspects of the disclosure.

### DETAILED DESCRIPTION

The present technology will now be described with respect to the following exemplary systems and methods.

### Example Systems

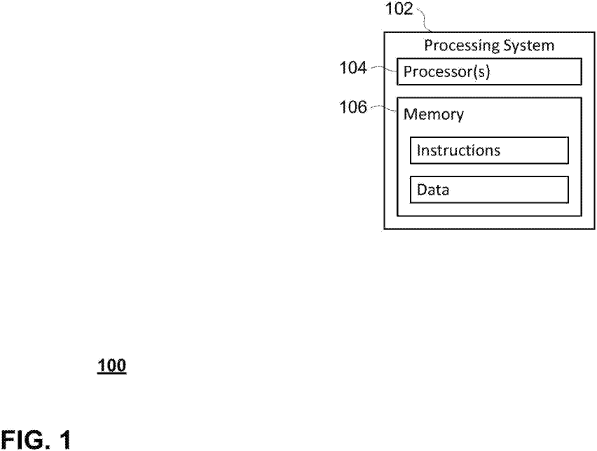

A high-level system diagram 100 of an exemplary processing system for performing the methods described herein is shown in FIG. 1. The processing system 102 may include one or more processors 104 and memory 106 storing instructions and data. The instructions and data may include the graph, the node embeddings, and the routines described herein. Processing system 102 may be resident on a single computing device. For example, processing system 102 may be a server, personal computer, or mobile device, and the graph, node embeddings, and routines may thus be local to that single computing device. Similarly, processing system 102 may be resident on a cloud computing system or other distributed system, such that the graph, node embeddings, and routines may reside on one or more different physical computing devices.

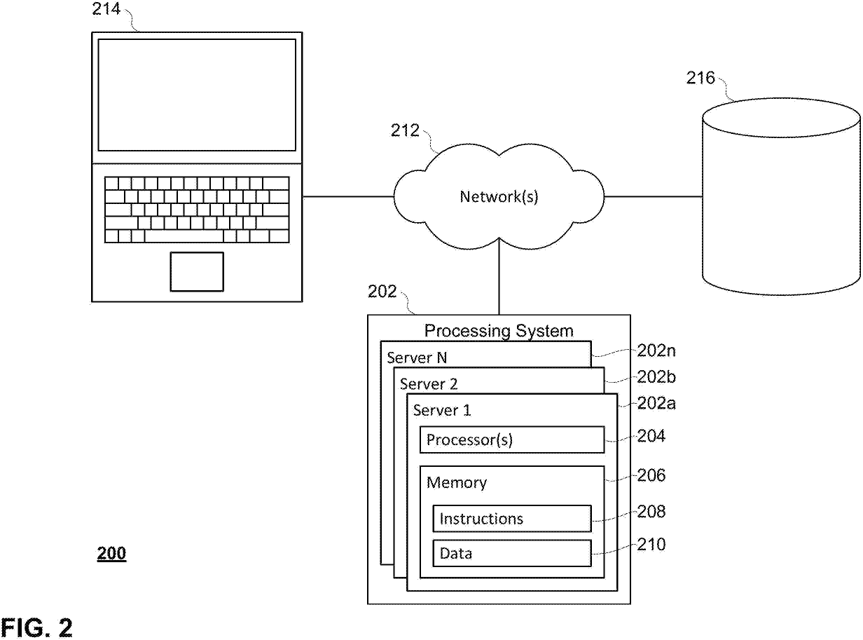

In this regard, FIG. 2 shows an additional high-level system diagram 200 in which an exemplary processing system 202 for performing the methods described herein is shown as a set of n servers 202a-202n, each of which includes one or more processors 204 and memory 206 storing instructions 208 and data 210. In addition, in the example of FIG. 2, the processing system 202 is shown in communication with one or more networks 212, through which it may communicate with one or more other computing devices. For example, the one or more networks 212 may allow a user to interact with processing system 202 using a personal computing device 214, which is shown as a laptop computer, but may take any known form including a desktop computer, tablet, smart phone, etc. Likewise, the one or more networks 212 may allow processing system 202 to communicate with one or more remote databases such as database 216. In this regard, in some aspects of the technology, database 216 may store the graph, node embeddings, and/or routines described herein, and thus may (along with processing system 202) form a distributed processing system for practicing the methods described below.

The processing systems described herein may be implemented on any type of computing device(s), such as any type of general computing device, server, or set thereof, and may further include other components typically present in general purpose computing devices or servers. Memory 106, 206 stores information accessible by the one or more processors 104, 204, including instructions 108, 208 and data 110, 210 that may be executed or otherwise used by the processor(s) 104, 204. Memory 106, 206 may be of any non-transitory type capable of storing information accessible by the processor(s) 104, 204. For instance, memory 106, 206 may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, touch screen and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

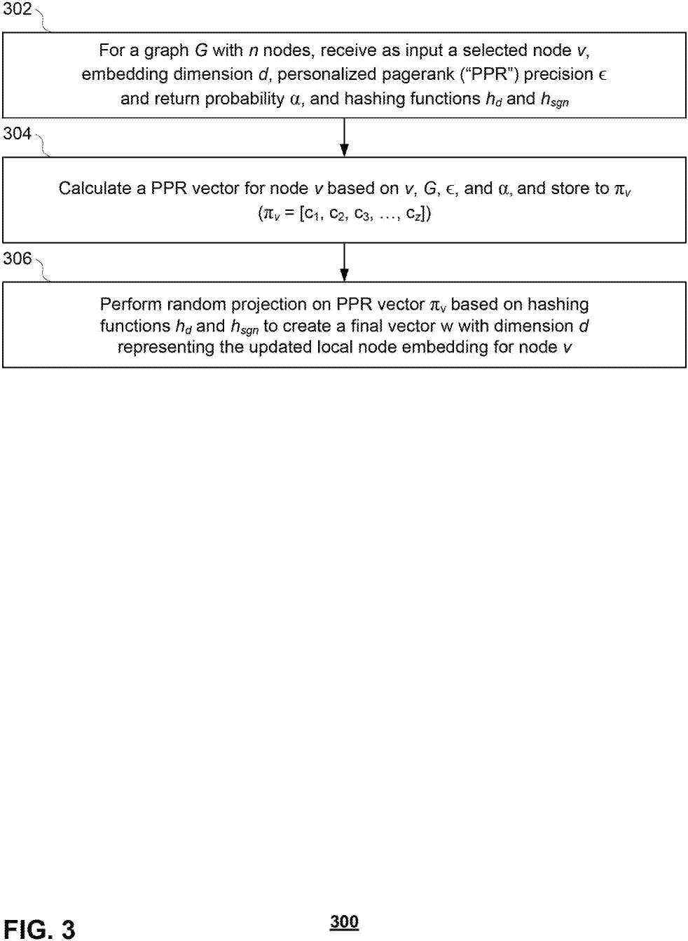

FIG. 3 depicts an exemplary method 300 showing how a processing system (e.g., processing system 102 or 202) may generate a local node embedding for a selected node v in a graph G with n total nodes, in accordance with aspects of the disclosure.

In step 302, the processing system receives as input the selected node v, a desired dimension d for the node embedding, a desired precision ∈ and return probability α to be used in calculating the personalized pagerank (“PPR”) vector, and random hashing functions h_{d} and h_{sgn}.

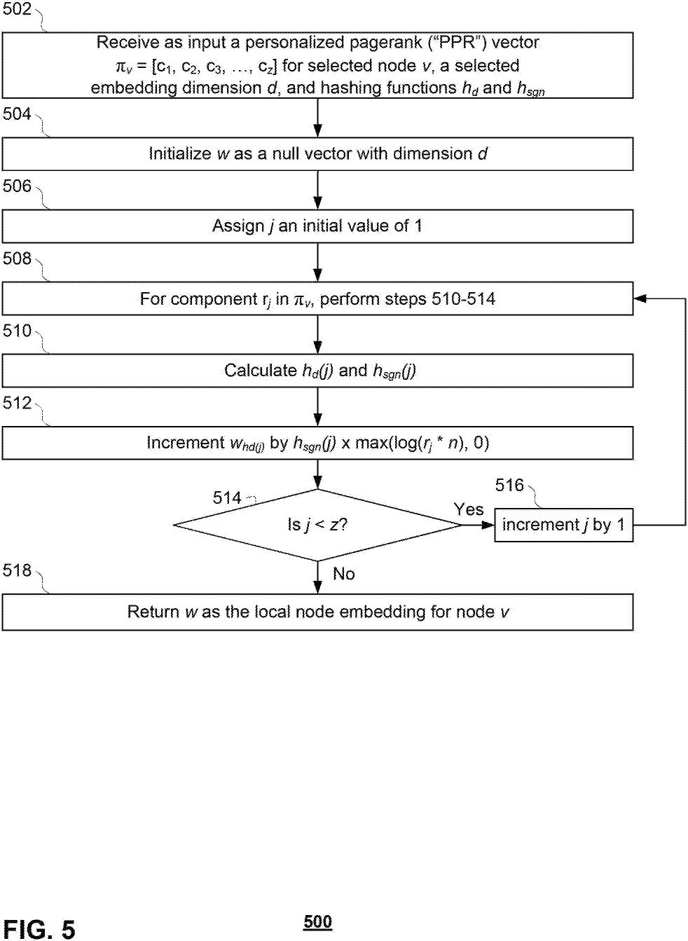

Functions h_{d} and h_{sgn} are global hash functions. In the example methods of FIGS. 3 and 5, h_{d} is a function randomly sampled from a universal hash family U_{d} that returns a natural number between 0 and (d - 1), and h_{sgn} is a function randomly sampled from a universal hash family U_{-1,1} that returns either -1 or 1. However, any suitable random-projection-based hashing strategy for reducing the dimensionality of the PPR vector may be used, so long as it provides an unbiased estimator for the inner-product value calculated in step 512 of FIG. 5 (below), and requires less than O(n) memory and provides a bounded variance. For example, in some aspects of the technology, the variance of the inner-product calculated in step 512 may be O(log(n²/d)).

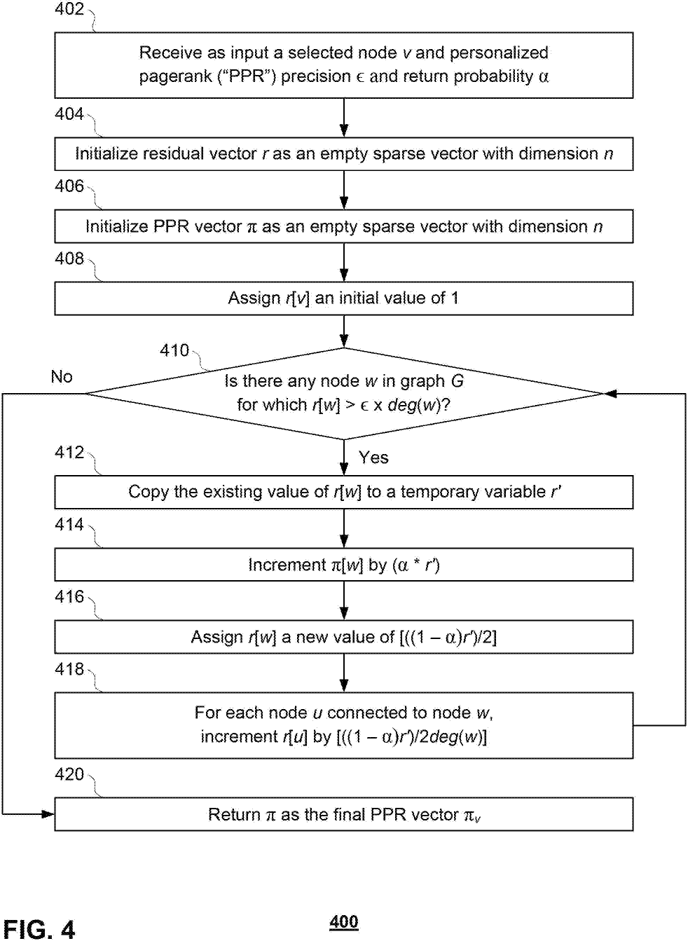

Precision ∈ is a value representing the error factor of the PPR approximation. This precision value ∈, together with the local topology of the graph, effectively determines how large of a neighborhood surrounding node v will need to be stored in short-term memory and processed in order to estimate the PPR vector for node v. In that regard, as the PushFlow routine described in the example methods of FIGS. 3 and 4 estimates the true PPR values up to a factor of ∈ for each node, a smaller ∈ value gives a better overall approximation, at the expense of an increased number of iterations and short-term memory required. The precision value ∈ may be “tuned” by testing different values of ∈ on the dataset until suitable results are achieved, and then using that value for future PPR estimates. For example, the value ∈ may be tuned such that the size of the PPR approximation does not exceed some predefined memory bound, e.g. an amount of memory available to a computing device, a memory cache size of a processor of a computing device or the like.

Return probability α is a value representing a probability of whether a given “random walk” from node v will end up returning (or “teleporting”) back to node v before reaching the end of the neighborhood (defined by precision value ∈). This return probability value α, together with the local topology of the graph, effectively determines how the PPR vector will spread out from node v. The return probability α may be a measured or assumed value. For example, if graph G represents a group of webpages, return probability α could be calculated based on how often a set of actual users surfing those webpages start from a given webpage end up back at that same webpage. However, in some aspects of the technology, the return probability α can simply be a selected value. In that regard, like the precision value ∈, the return probability α may also be “tuned” by testing different values of α on the dataset until suitable results are achieved, and then using that value for future PPR estimates.

In step 304, the processing system calculates a PPR vector for node v based on graph G, node v, precision value ∈, and return probability α, and stores that PPR vector to π_{ν}. For the purposes of illustrating the exemplary methods of FIGS. 3-5, we will assume that π_{ν} is a vector with z components [c1, c2, c3, ... , c_{z}]. Each component c of vector π_{ν} is an index-value pair, such that cⱼ = (j, rⱼ). Node identifier j can be an integer, or any other unique, hashable identifier such as a string. Using index-value pairs for each component of π_{ν} allows the PPR vector to store only non-zero elements. Thus, while a PPR vector will have n values for a graph with n total nodes, using index-value pairs allows π_{ν} to store only the non-zero values, resulting in a smaller number of only z total components.

In the example of FIGS. 3 and 4, the processing system will calculate the PPR vector for node v using the Sparse Personalized PageRank routine known as PushFlow, which is described in Andersen et al., Using pagerank to locally partition a graph, Internet Mathematics 4.1 (2007), pp. 35-64. However, the present technology may utilize any routine for computing PPR that employs a heuristic that guarantees its locality, such as the PPR routines described in: Bahmani et al., Fast Incremental and Personalized PageRank, Proceedings of the VLDB Endowment, vol. 4, No. 3 (2011), pp. 173-184; Lofgren, et al., Personalized PageRankto α Target Node , arXiv:1304.4658v2, Apr. 11, 2014; or Yang et al., P-Norm Flow Diffusion for Local Graph Clustering, SIAM Workshop on Network Science 2020, available at https://ns20.cs.cornell.edu/abstracts/SIAMNS_2020_paper_12.pdf. In addition, in some aspects of the technology, an adjacency matrix representing all connections between all nodes within graph G may be used instead of a PPR vector, and that adjacency matrix may then be randomly projected (as described below). Further, in some aspects of the technology the adjacency matrix may be raised to a power and then randomly projected (again, as described below).

In step 306, the processing system performs random projection on PPR vector π_{ν} based on random hashing functions h_{d} and h_{sgn}, which results in a final vector w of dimension d representing the updated local node embedding for node v. As noted above, this vector w may be used for downstream tasks specific to node v such as classifying node v, or generating link predictions for node v. In that regard, in addition to creating an updated vector for node v, the method of FIG. 3 may be repeated for one or more additional nodes adjacent to node v so as to ensure that any such classifications or node predictions for node v will also take into account any updated attributes of its adjacent nodes. Likewise, for applications in which additional updated representations are needed for other nodes elsewhere in the graph (e.g., nodes that are not adjacent to node v), the method of FIG. 3 may be repeated for each of those remote nodes.

In addition, as the methods described herein create updated representations for node v that are consistent with the representations of the other nodes in graph G, the processing system may generate updated node representations on the fly whenever a node is modified. As such, vector w may be integrated with existing node embeddings for graph G so that downstream tasks that rely upon an entire graph embedding (e.g., visualization tasks) may be performed on a fully updated graph embedding.

FIG. 4 depicts an exemplary method 400 showing how a processing system (e.g., processing system 102 or 202) may generate a PPR vector for a selected node v in a graph G with n total nodes, in accordance with aspects of the disclosure. In that regard, in some aspects of the technology, method 400 may be used to calculate the PPR vector as described above with respect to step 304 of FIG. 3.

In step 402, the processing system receives as input the selected node v, and the precision ∈ and return probability α to be used in calculating the PPR vector (each of which has been described above). The processing system will also have access to graph G. However, graph G need not be stored in short-term memory for the purposes of method 400, thus reducing short-term memory consumption.

In step 404, the processing system initializes residual vector r as an empty sparse vector with dimension n. In other words, residual vector r is initialized as a sparse vector with n possible components, each of which is initially empty. Again, n is a number representing the number of total nodes in graph G.

In step 406, the processing system initializes PPR vector π as an empty sparse vector with dimension n. Thus, PPR vector π is also initialized as a sparse vector with n possible components, each of which is initially empty.

In step 408, the element of residual vector r corresponding to selected node v, or r[v], is assigned an initial value of 1.

In step 410, a loop begins which will repeat steps 412-418 while there exists any node w in graph G for which that node’s residual value r[w] is greater than that node’s degree multiplied by the selected precision value ∈. In that regard, the degree of node w, or deg(w) represents the number of nodes that node w is connected to. Thus, on the first pass, because r[v] has been initialized to 1, the condition may be satisfied with respect to node v (assuming reasonable values for ∈ and deg(w)), and the loop will begin as shown by the “Yes” arrow pointing to step 412).

In step 412, the processing system copies the existing value of r[w] to a temporary variable. For the purposes of illustrating example method 400, that temporary variable will be referred to as r′.

In step 414, the processing system increments the existing value of π[w] by (α * r′). This results in that incremented value being stored in the component of π associated with node w, implicitly creating an index-value pair between node w and the incremented value. For example, on the first step where π is initially empty, step 414 will result in (α * r′) being stored to π[w], which will implicitly create an index value pair within π of (w, (α * r′)).

In step 416, the processing system assigns r[w] a new value according to Equation 1 below. As Equation 1 multiplies the stored value of r[w], or r′, by the fraction ((1 - α)/2), this results in r[w] being reduced in value.

$$r \left[w\right] = \frac{\left(1 - a\right) {r}^{′}}{2}$$

In step 418, for each node u connected to node w, the processing system increments that node’s residual value r[u] according to Equation 2 below.

$$r \left[u\right] = r \left[u\right] + \frac{\left(1 - a\right) {r}^{′}}{2 deg \left(w\right)}$$

In this case, as deg(w) will return the number of nodes connected to node w, Equation 2 results in the residual value of each node u being increased by an equal share of node w’s original residual value. In all, node w’s original residual value r′ will thus be split up as follows during one pass through steps 412-418:
(α * r′) will be allocated to π[w] as described in step 414;
[((1 - α)r′)/2] will remain in r[w] as described in step 416; and
[((1 - α)r′)/2] will be split equally among each r[u] as described in step 418.

Steps 410-418 thus result in a node w with “too much” residual value (as determined by the test in step 410) having that residual value flow away from r[w], and into node w’s PPR value, and the residuals of its neighboring nodes u.

After each pass through steps 410-418, the loop will return to step 410 (as shown by the arrow connecting step 418 back to step 410) for another determination of whether there are any nodes with “too much” residual value. In that regard, as a result of how residual value gets redistributed in steps 410-418, each pass has the potential to create additional nodes with “too much” residual value. Accordingly, the loop of steps 410-418 will repeat until, at step 410, the processing system determines that there are no remaining nodes with “too much” residual value. At this point, the existing form of the π vector will be the final PPR vector for node v, and the method will proceed to step 420 as shown by the “No” arrow.

The π vector produced at the conclusion of steps 410-418 will be a sparse PPR vector for node v containing only the nonzero values (and their associated index value) that were stored to π[w] in each pass through steps 410-418. Accordingly, in step 420, the processing system will return the sparse PPR vector as the final PPR vector π_{ν}.

While the resulting PPR vector π_{ν} may have a far lower dimensionality than would if it were not sparse (and thus also had to store zero values for any nodes not updated in the passes through steps 410-418), even π_{ν} may nevertheless have a dimensionality that is too high for it to be used for certain tasks and/or on certain hardware platforms. In that regard, the relatively high dimensionality of π_{ν} may make it impractical or impossible to use as input to other models, as a large input vector increases the size (and speed) of the model that uses it. For example, a π_{ν} vector with entries for 1 million nodes will require the model to have at least 1 million * k parameters, where k is the output size of the first hidden layer. A model of that size may thus become too big to fit within the memory of a given computing device. Likewise, larger models take longer to train and evaluate.

Thus, to produce a more usable local node embedding, the present technology relies upon random projection to reduce the dimensionality of π_{ν}. This enables π_{ν} to be converted into a low-dimensional embedding that models can learn to generalize on with only a small number of training examples. The smaller dimensionality of the embedding also allows models to be much smaller, and requires less computing power, so that the embedding can be used on computing devices such as mobile phones, tablets, and personal computers as opposed to larger and more powerful computing devices such as enterprise-level hardware. In addition, smaller individual node embeddings will yield a proportionally smaller graph embedding, allowing full-graph representations to be used in situations where instantiating a full PPR matrix would simply not be feasible.

FIG. 5 depicts an exemplary method 500 showing how a processing system (e.g., processing system 102 or 202) may perform random projection of a PPR vector to generate a local node embedding for a selected node v, in accordance with aspects of the disclosure. In that regard, in some aspects of the technology, method 500 may be used to perform the random projection described above with respect to step 306 of FIG. 3.

In step 502, the processing system receives as input the PPR vector π_{ν} to be randomly projected, a desired dimension d for the node embedding, and the random hashing functions h_{d} and h_{sgn} (each of which has been described above).

In step 504, the processing system initializes a null vector w with dimension d. In other words, w is initialized as a vector with d components, each of which is 0.

In step 506, the processing system initializes a variable j with a value of 1.

In step 508, a loop begins in which, for each component cⱼ in π_{ν}, steps 510-514 are performed. Again, as described above, π_{ν} is composed of the non-zero values of the PPR vector for node v, and each component cⱼ is an index-value pair such that cⱼ = (j, rⱼ).

In step 510, the processing system calculates h_{d}(j) and h_{sgn}(j) using the global hash functions described above.

In step 512, the processing system uses the random natural number returned by hashing function h_{d}(j) to select a component of vector w to modify (represented herein as

$$\left({w}_{{h}_{d} \left(j\right)}\right) ,$$

and increments that selected component of vector w according to Equation 3, below.

$${w}_{{h}_{d} \left(j\right)} = {w}_{{h}_{d} \left(j\right)} + {h}_{s g n} \left(j\right) \times max \left(log \left({r}_{j} ∗ n\right) , 0\right)$$

In step 514, the processing system determines whether the current value of j is less than z, the number of components in the PPR vector π_{ν}. If so, the processing system will follow the “Yes” arrow to step 516. At step 516, the processing system will increment j by one, and then follow the arrow back to step 508 so that steps 510-514 may be repeated for the next component of π_{ν}.

This loop will continue to repeat for each next value of j until, at step 514, the processing system determines that j is not less than z, at which point the processing system will follow the “No” arrow to step 518. At step 518, the processing system will return vector w, which represents the updated local node embedding for node v.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A processing system, comprising:
a memory; and
one or more processors coupled to the memory and configured to perform the following operations:
obtain a graph having a plurality of nodes from a database;
generate a personal pagerank vector for a given node of the plurality of nodes; and
produce an embedding vector for the given node by randomly projecting the personal pagerank vector, wherein the embedding vector has lower dimensionality than the personal pagerank vector.

2. The system of claim 1, wherein the one or more processors are further configured to perform the following operations, and to perform one or more of the following operations in parallel with one or more of the operations of claim 1:
generate an additional personal pagerank vector for an additional node of the plurality of nodes, the additional node being different from the given node; and
produce an additional embedding vector for the additional node by randomly projecting the additional personal pagerank vector, wherein the additional embedding vector has lower dimensionality than the additional personal pagerank vector.

3. The system of claim 1, wherein the one or more processors are further configured to generate the personal pagerank vector for the given node based at least in part on a precision value.

4. The system of claim 1, wherein the one or more processors are further configured to generate the personal pagerank vector for the given node based at least in part on a return probability.

5. The system of claim 1, wherein the one or more processors are further configured to generate the personal pagerank vector as a sparse vector.

6. The system of claim 1, wherein the one or more processors are further configured to produce the embedding vector for the given node by randomly projecting the personal pagerank vector based at least in part on a preselected dimensionality for the embedding vector.

7. The system of claim 1, wherein the one or more processors are further configured to produce the embedding vector for the given node by randomly projecting the personal pagerank vector based at least in part on a one or more hashing functions.

8. The system of claim 1, wherein the one or more processors are further configured to update an embedding for the graph based on the embedding vector for the given node.

9. The system of claim 1, wherein the one or more processors are further configured to produce a link prediction based at least in part on the embedding vector for the given node, wherein the link prediction represents a prediction of a new link between the given node and another of the plurality of nodes.

10. The system of claim 1, wherein the one or more processors are further configured to produce a node classification based at least in part on the embedding vector for the given node, wherein the node classification represents a prediction of information to be associated with the given node based on one or more features of other nodes of the plurality of nodes that are adjacent to the given node.

11. A computer-implemented method, comprising steps of:
obtaining, with one or more processors of a processing system, a graph having a plurality of nodes from a database;
generating, with the one or more processors, a personal pagerank vector for a given node of the plurality of nodes; and
producing, with the one or more processors, an embedding vector for the given node by randomly projecting the personal pagerank vector, wherein the embedding vector has lower dimensionality than the personal pagerank vector.

12. The method of claim 11, further comprising the following steps, one or more of which are performed in parallel with one or more of the steps of claim 11:
generating, with the one or more processors, an additional personal pagerank vector for an additional node of the plurality of nodes, the additional node being different from the given node; and
producing, with the one or more processors, an additional embedding vector for the additional node by randomly projecting the additional personal pagerank vector, wherein the additional embedding vector has lower dimensionality than the additional personal pagerank vector.

13. The method of claim 11, wherein generating the personal pagerank vector for the given node is based at least in part on a precision value.

14. The method of claim 11, wherein generating the personal pagerank vector for the given node is based at least in part on a return probability.

15. The method of claim 11, wherein the personal pagerank vector is a sparse vector.

16. The method of claim 11, wherein producing the embedding vector for the given node by randomly projecting the personal pagerank vector is based at least in part on a preselected dimensionality for the embedding vector.

17. The method of claim 11, wherein producing the embedding vector for the given node by randomly projecting the personal pagerank vector is based at least in part on one or more hashing functions.

18. The method of claim 11, further comprising updating the embedding for the graph based on the embedding vector for the given node.

19. The method of claim 11, further comprising producing a link prediction based at least in part on the embedding vector for the given node, wherein the link prediction represents a prediction of a new link between the given node and another of the plurality of nodes.

20. The method of claim 11, further comprising producing a node classification based at least in part on the embedding vector for the given node, wherein the node classification represents a prediction of information to be associated with the given node based on one or more features of other nodes of the plurality of nodes that are adjacent to the given node.
